(19) United States
(12) Patent Application Publication
(10) Pub. No.: US 2023/0330698 A1
(43) Pub. Date: Oct. 19, 2023

(54) SURFACE FINISHING TROWELS, SYSTEMS, AND METHODS THEREOF

(71) Applicant: M-B-W, Inc., Slinger, WI (US)

(72) Inventor: Benjamin James Paske, Cedarburg, WI (US)

(73) Assignee: M-B-W, Inc., Slinger, WI (US)

(21) Appl. No.: 18/299,284

(22) Filed: Apr. 12, 2023

Related U.S. Application Data
(60) Provisional application No. 63/331,961, filed on Apr. 18, 2022.

(51) Int. Cl. B05C 17/10

(52) U.S. Cl. CPC B05C 17/10

(57) ABSTRACT

A trowel for finishing a material surface includes a blade assembly having a blade configured to finish the material surface and a pitch mechanism coupled to the blade and defining a first axis about which the pitch mechanism is rotatable. As the pitch mechanism rotates about the first axis, the pitch mechanism pivots the blade about the first axis. A handle is operably coupled to the blade assembly and extends along a second axis that is transverse to the first axis. The handle is rotatable about the second axis and rotation of the handle about the second axis causes rotation of the pitch mechanism about the first axis and pivoting of the blade.

### CROSS-REFERENCE TO RELATED APPLICATION

The present disclosure is based on and claims priority to U.S. Provisional Patent Application No. 63/331,961 filed Apr. 18, 2022, the disclosure of which is incorporated herein by reference.

### FIELD

The present disclosure relates to relates to surface finishing trowels and specifically to trowels that are manually moved along a material surface.

### BACKGROUND

The following U.S. patents are incorporated herein by reference in entirety.

U.S. Pat. No. 4,784,519 discloses a directional control mechanism for a surface working machine. The surface working machine includes a frame that carries at least a pair of rotors each having a vertical rotatable shaft. Surface working means, including a plurality of radially extending blades, is operably connected to the shaft and rotates therewith.

U.S. Pat. No. 5,096,330 discloses a pitch control mechanism for a surface finishing machine. The machine includes a series of tiltable horizontal blades carried by a rotor and the blades are adapted to rotate in contact with and finish a concrete surface. The pitch control mechanism for tilting the blades includes an internally threaded sleeve located within the handle of the machine.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a trowel for finishing a material surface includes a blade assembly having a blade configured to finish the material surface and a pitch mechanism coupled to the blade and defining a first axis about which the pitch mechanism is rotatable. As the pitch mechanism rotates about the first axis, the pitch mechanism pivots the blade about the first axis. A handle is operably coupled to the blade assembly and extends along a second axis that is transverse to the first axis. The handle is rotatable about the second axis and rotation of the handle about the second axis causes rotation of the pitch mechanism about the first axis and pivoting of the blade.

Optionally, pivoting the blade changes pitch angle defined between the blade and the material surface. Optionally, the blade has a first edge and rotation of the handle in a first rotational handle direction causes the first edge to pivot away from the material surface. Optionally, rotation of the handle in a second rotational handle direction opposite the first rotational handle direction causes the first edge to pivot toward the material surface. Optionally, the first edge extends parallel to the first axis. Optionally, the blade includes a second edge opposite the first edge, and rotation of the handle in a second rotational handle direction opposite the first rotational handle direction causes the second edge to pivot away from the material surface and the first edge to pivot toward the material surface. Optionally, the first edge and the second edge both extend parallel to the first axis. Optionally, the handle includes a shaft with a slot and the pitch mechanism includes a post that extends into the slot and rotation of the handle causes the shaft to act on the post and thereby rotate the pitch mechanism about the first axis. Optionally, the post extends parallel to the first axis. Optionally, the slot is a spiral slot. Optionally, the slot is recessed in the shaft. Optionally, the slot has a first slot end and a second slot end and rotation of the handle in a first rotational handle direction causes the shaft to move the post toward the first slot end. Optionally, rotation of the handle in a second rotational handle direction opposite the first rotational handle direction causes the shaft to move the post toward the second slot end. Optionally, the pitch mechanism includes a vibration device configured to generate vibrations that vibrate the blade. Optionally, a rechargeable battery is for powering the vibration device. Optionally, a vibration device is centered on the first axis.

In certain examples, a method for pivoting a blade of a trowel used for finishing a material surface includes providing a pitch mechanism coupled to the blade and that defines a first axis about which the pitch mechanism is rotatable; operably coupling a handle to the pitch mechanism and the handle extends along and is rotatable about a second axis that is transverse to the first axis; and rotating the handle about the second axis to thereby rotate the pitch mechanism and pivot the blade.

Optionally, pivoting the blade changes pitch angle defined between the blade and the material surface. Optionally, rotation of the handle in a first rotational handle direction causes a first edge of the handle to pivot away from the material surface, and rotation of the handle in a second rotational handle direction opposite the first rotational handle direction causes the first edge to pivot toward the material surface. Optionally, the handle includes a shaft with a slot and the pitch mechanism includes a post that extends into the slot and the rotating the handle causes the shaft to act on the post and thereby rotate the pitch mechanism about the first axis.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example trowel of the present disclosure.

FIG. 2 is a side view of the trowel of FIG. 1 after rotation of a handle in a first rotational handle direction.

FIG. 3 is a side view of the trowel of FIG. 1 after rotation of the handle in a second rotational handle direction.

FIG. 4 is a top-down plan view of the trowel of FIG. 1 without a housing.

FIG. 5 is an exploded view of the trowel of FIG. 1 without a blade.

FIG. 6 is a perspective view of the trowel of FIG. 1 with the blade in a first blade position.

FIG. 7 is a perspective view of the trowel of FIG. 1 with the blade in a second blade position.

FIG. 8 is a perspective view of the trowel of FIG. 1 with the blade in a third blade position.

### DETAILED DESCRIPTION

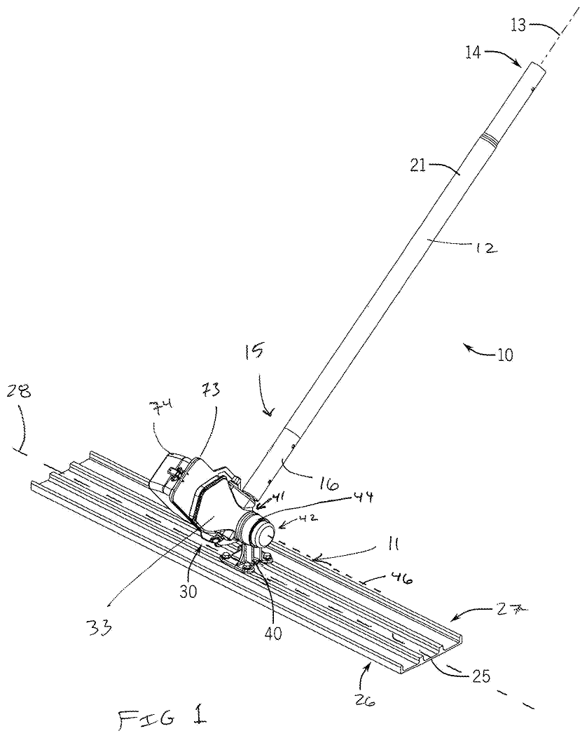

Referring to FIG. 1, an exemplary trowel 10 according to the present disclosure is depicted. Generally, the trowel 10 includes a handle 12 coupled to a blade assembly 11, and the blade assembly 11 has a blade 25 that engages and/or contacts a material surface (e.g., a top surface of an uncured concrete slab). An operator engages the handle 12 to thereby maneuver the blade 25 along the material surface and finish (e.g., smooth) the material surface. Persons of ordinary skill in the art will recognize at the blade 25 is moved across the material surface, fine particles in the material are urged to the surface such that the material surface is finished (e.g., smoothed). It will be recognized that the blade 25 applies a pressure force against the material surface via the portion or surface area of the blade 25 that acts with the material surface, and the pressure forces applied to the material surface can be increased by decreasing the portion of surface area of the blade 25 that acts contact with the material surface. It may also be advantageous for the operator to adjust a pitch angle of the blade 25 relative to the material surface to properly smooth the material surface and/or avoid “cutting” into the material surface. Through research and experimentation, the Applicants developed the trowels 10 of the present disclosure described hereinbelow that permit the operator to easily and quickly change the pitch angle of the blade 25 relative to the material surface and/or apply different pressures to material surface thereby allowing the operator to properly finish the material surface.

The trowel 10 includes a handle 12 with a body 21 (e.g., wooden or metal rod), and the handle 12 extends along an axis 13. The handle 12 has a first handle end 14 and an opposite second handle end 15. The handle 12 includes a shaft, e.g., a slotted shaft 16, at the second handle end 15. Advantageously, the second handle end 15 can be decoupled from the slotted shaft 16 (e.g., in the event the handle 12 is damaged) such that another handle 12 can be coupled to the slotted shaft 16. In these examples, the slotted shaft 16 of the handle 12 remains coupled to the blade assembly 11. Note that in other examples, the slotted shaft 16 is integrally formed with the handle 12, and in these examples, the handle 12 with the slotted shaft 16 can be decoupled from the blade assembly 11.

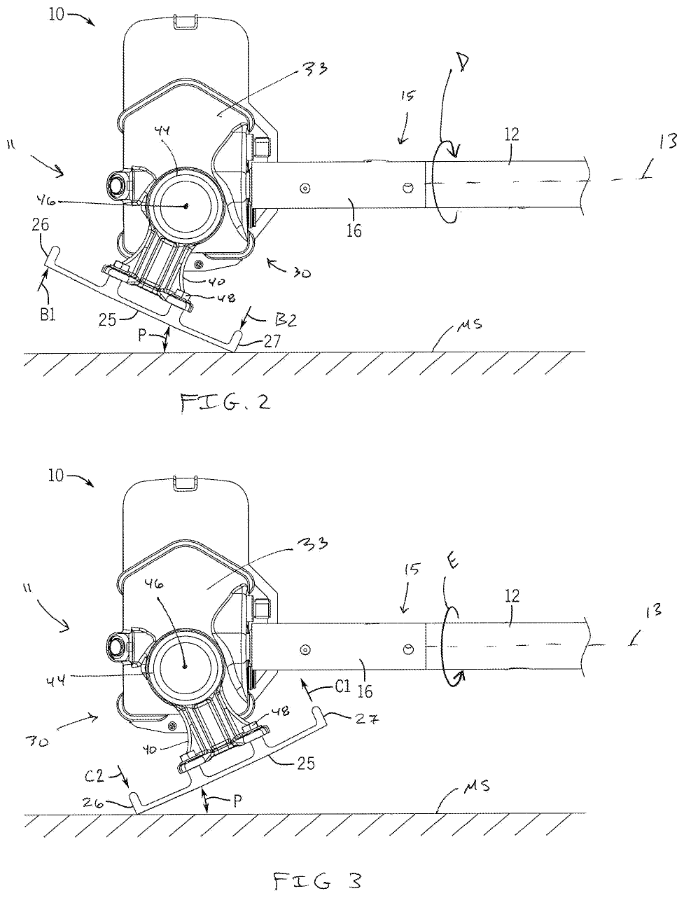

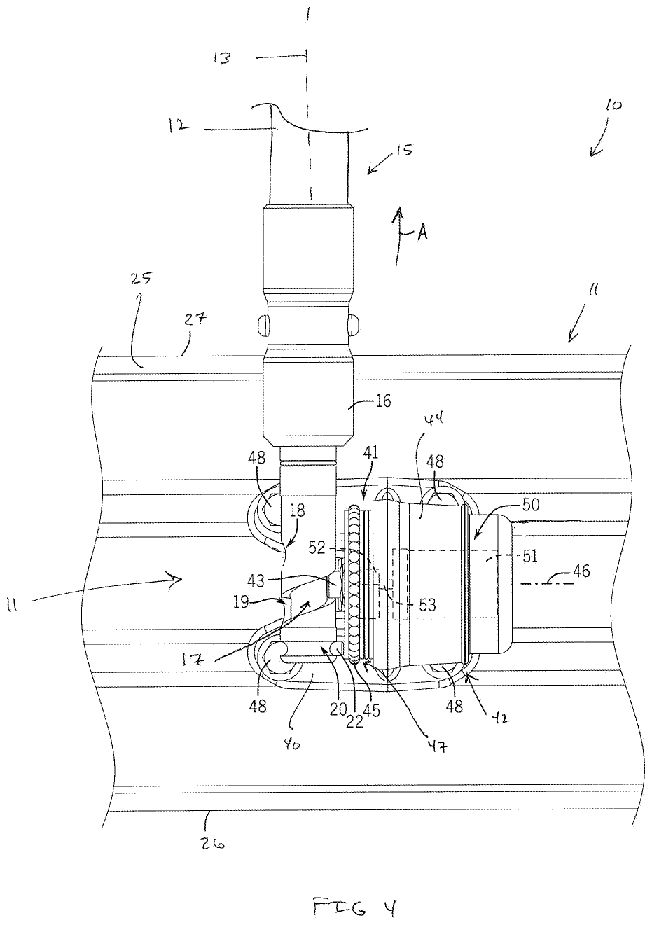

As will be described in greater detail herein below, the blade assembly 11 includes a pitching mechanism 30 and a blade 25 coupled thereto. The slotted shaft 16 is operably coupled to the pitching mechanism 30 such as rotation of the handle 12 causes the pitch angle of the blade 25 relative to the material surface SF (see FIGS. 2-3) to change. In one specific example (referring to FIG. 2), the operator rotates the handle 12 about the axis 13 in a first rotational direction (see arrow D; e.g. clockwise direction) to pivot a front first edge 26 of the blade 25 away from the material surface MS (see arrow B1) and an opposite rear second edge 27 of the blade 25 toward the material surface MS (see arrow B2). The pitch angle P changes as the handle 12 is rotated. As depicted in FIG. 3, opposite rotation of the handle 12 about the axis 13 in a second rotational direction (see arrow E; e.g., counterclockwise) causes the second edge 27 to be pivoted away from the material surface MS (see arrow C1) and the first edge 26 to be pivoted toward the material surface MS (see arrow C2).

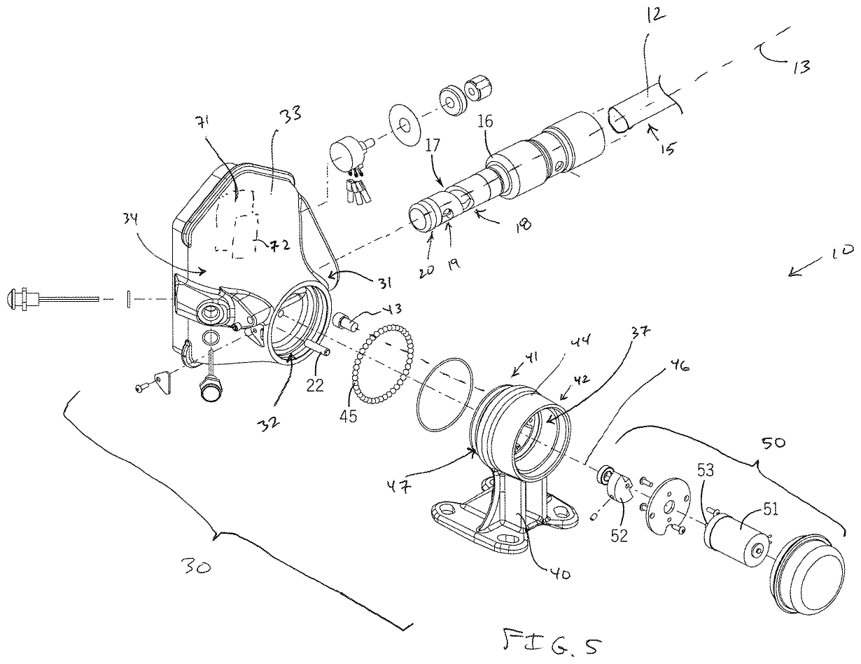

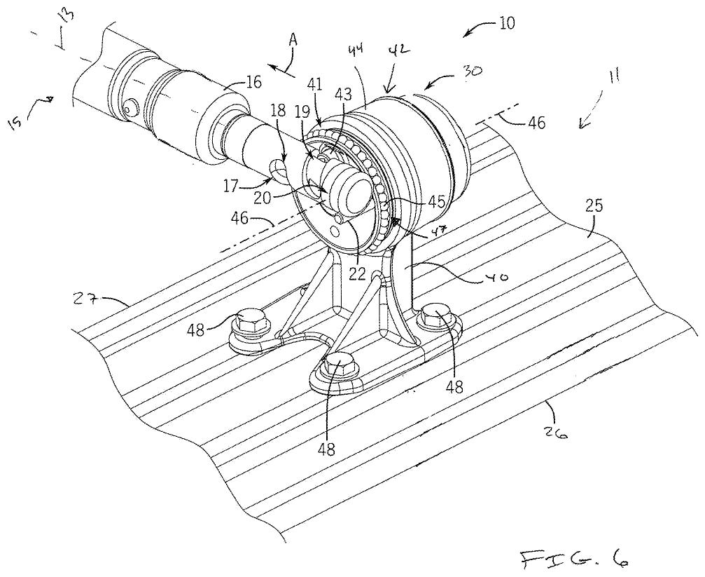

Referring now to FIGS. 4-5, an example pitch mechanism 30 according to the present disclosure is depicted in greater detail. The pitch mechanism 30 has a housing 33 (FIG. 5) that protects the internal components (described further herein) of the pitch mechanism 30 from debris and being damaged and defines an interior space 34 in which the internal components are located. Note that FIG. 4 excludes the housing 33 to thereby expose internal components of the pitch mechanism 30. The housing 33 defines a first opening 31 through which the slotted shaft 16 extends. The housing 33 also defines a second opening 32 through which a frame 44 extends.

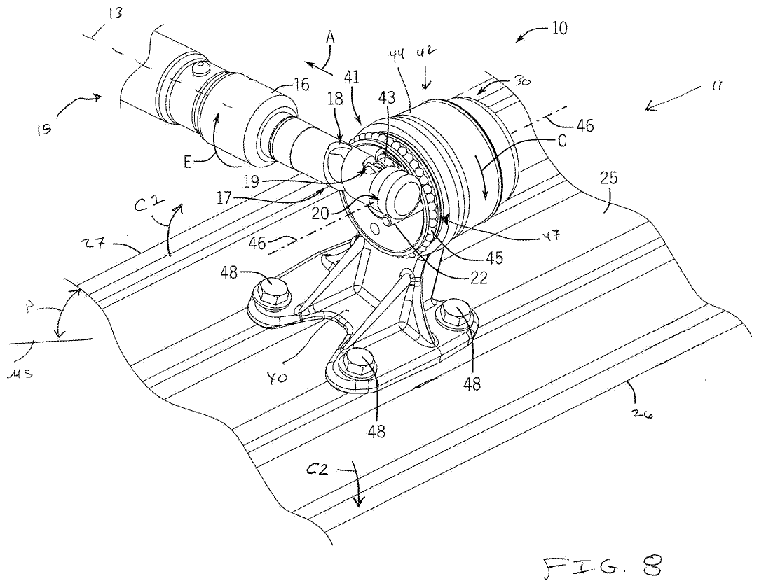

The slotted shaft 16 defines a slot 17 having a first slot end 18 and an opposite second slot end 19. The slot 17 is generally spiral-shaped and is radially offset from the axis 13 about which the slotted shaft 16 is generally centered. The slot 17 is recessed into the shaft 16. Note that the first slot end 18 is axially offset from the second slot end 19. The housing 33 also includes a second opening 32 that is in communication with the first opening 31, and the second opening 32 receives a first end 41 of the frame 44 (described further therein). The slotted shaft 16 also includes a groove 20 (e.g., annular groove) in which a retaining pin 22 (see FIG. 7) is received. In certain other examples, the shaft 16 includes projections (e.g., threads) that radially outwardly extend from the exterior surface of the shaft 16 and define the slot 17 therebetween and radially outward of the exterior surface.

The retaining pin 22 is fixed relative to the housing 33 and may be coupled to the housing 33 and/or the frame 44. The retaining pin 22 is configured to retain the slotted shaft 16 in the housing 33 and prevent axial movement of the slotted shaft 16 in a first axial direction (see arrow A on FIG. 4) or an opposite second axial direction (see arrow B on FIG. 5). Note that the pin 22 remains in the groove 20 as the handle 12 is rotated.

The frame 44 includes a mounting bracket 40 fixedly coupled thereto such at the frame 44 and the mounting bracket 40 move together. The mounting bracket 40 is for coupling to the blade 25 with one or more bolts 48.

The frame 44 includes a closed first end 41 and an opposite open second end 42. The first end 41 defines an annular groove 47 in which bearings 45 are positioned, and the bearings 45 permit rotation of the frame 44 relative to the housing 33 about an axis 46 while the frame 44 and the housing 33 remain coupled to each other. A post 43 is coupled to the first end 41 and extends into the slot 17 of the slotted shaft 16. The post 43 is offset from and extends parallel to the axis 46. The post 43 is also fixed to the frame 44 such that as the slotted shaft 16 acts on the post 43 (described further herein), the post 43 and the frame 44 rotate about the axis 46. In certain examples, the axis 46 is parallel and offset from a blade axis 28 along which the blade 25 extends (see FIG. 1). Further, in certain examples the axis 46 defined by the frame 44 and the pitch mechanism 30 (e.g., first axis 46) is transverse to the axis 13 (e.g., second axis 13) along which the handle 12 extends. In one specific non-limiting example, the first axis 46 and the second axis 13 are perpendicular to each other. In certain examples, the edges 26, 27 extend parallel with the blade axis 28 and the axis 46.

The second end 42 permits insertion of a vibration device 50 into a chamber 37 defined in the frame 44. The vibration device 50 is configured to generate vibrations that vibrate the blade 25. Any suitable vibration device 50 can vary utilized. In the example depicted in FIG. 5, the vibration device 50 includes a motor 51 and an eccentric member 52 coupled to the motor 51 via a shaft 53. The motor 51 is electrically coupled to a power supply (e.g., rechargeable battery) that supplies electrical power to the motor 51 which thereby rotates the eccentric member 52 to generate vibrations. In certain examples, the vibration device 50 is centered on the axis 46.

In one non-limiting example, the power supply for supplying power to the vibration device 50 is a battery 71 (e.g., single-use battery, rechargeable battery). The battery 71 is positioned in the interior space 34 defined by the housing 33. The battery 71 is connected to a socket 72 that releasably couples to the battery 71. The socket 72 is also electrically coupled to the vibration device 50 via one or more electrical connectors (not depicted, e.g., wires). The housing 73 includes an operable cover 74 such that the battery 71 can be accessed and recharged/removed/replaced. The socket 72 and/or the electrical connectors may be part of an electrical system (not shown) which may also include other electrical components such as wires, circuit boards, and switches.

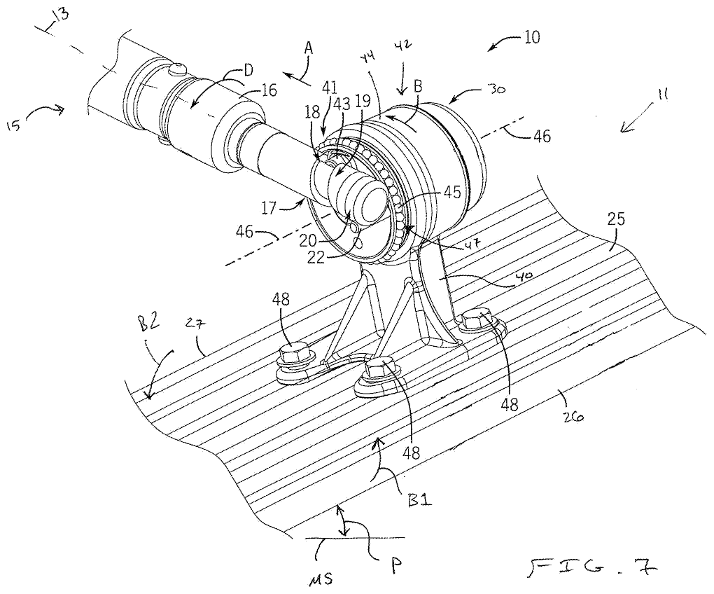

Referring now to FIGS. 6-8, an example operational sequence for operating the trowel 10 is depicted. FIG. 6 depicts the blade 25 in a first blade position in which the blade lies flush with the material surface MS (FIG. 2) such that the pitch angle P between the bottom of the blade 25 and the material surface is 0.0 degrees. Note that the post 43 is in an intermediate position within the slot 17 between the slots ends 18, 19.

The operator can move the blade 25 into a second blade position (depicted in FIG. 7) in which the first edge 26 is pivoted away from and spaced apart from the material surface MS (see also FIG. 2) by rotating the handle 12 about the axis 13 in the first rotational handle direction (see arrow D; e.g. clockwise direction) such that the frame 44 is rotated above the axis 46 and the first edge 26 of the blade 25 is pivoted away from the material surface MS (see arrow B1) and the pitch angle (see angle P on FIG. 2) changes. The second edge 27 is pivoted toward the material surface (see arrow B2). As the operator rotates the handle in the first rotational handle direction (see arrow D), the side surfaces of slotted shaft 16 that define the slot 17 act on (e.g., cam) and move the post 43 in a first rotational handle direction (see arrow B) until the post 43 is at the first slot end 18. Note that FIG. 7 depicts the post 43 near the first slot end 18. The frame 44 rotates with the post 43 in generally the first rotational direction and relative to the housing 33. As such, the blade 25 is moved as noted above.

Similarly, the operator can move the blade 25 into a third blade position (depicted in FIG. 8) in which the second edge 27 is pivoted away from and spaced apart from the material surface MS (see also FIG. 2) by rotating the handle 12 about the axis 13 in the second rotational handle direction (see arrow E; e.g. counterclockwise direction) such that the frame 44 is rotated above the axis 46 and the second edge 27 of the blade 25 is pivoted away from the material surface MS (see arrow C1) and the pitch angle (see angle P on FIG. 2) changes. The first edge 26 is pivoted toward the material surface (see arrow C2). The frame 44 rotates with the post 43 in generally the second rotational direction and relative to the housing 33. As such, the blade 25 is moved as noted above.

In certain examples, a trowel for finishing a material surface includes a blade assembly having a blade configured to finish the material surface and a pitch mechanism coupled to the blade and defining a first axis about which the pitch mechanism is rotatable. As the pitch mechanism rotates about the first axis, the pitch mechanism pivots the blade about the first axis. A handle is operably coupled to the blade assembly and extends along a second axis that is transverse to the first axis. The handle is rotatable about the second axis and rotation of the handle about the second axis causes rotation of the pitch mechanism about the first axis and pivoting of the blade.

Optionally, pivoting the blade changes pitch angle defined between the blade and the material surface. Optionally, the blade has a first edge and rotation of the handle in a first rotational handle direction causes the first edge to pivot away from the material surface. Optionally, rotation of the handle in a second rotational handle direction opposite the first rotational handle direction causes the first edge to pivot toward the material surface. Optionally, the first edge extends parallel to the first axis. Optionally, the blade includes a second edge opposite the first edge, and rotation of the handle in a second rotational handle direction opposite the first rotational handle direction causes the second edge to pivot away from the material surface and the first edge to pivot toward the material surface. Optionally, the first edge and the second edge both extend parallel to the first axis. Optionally, the handle includes a shaft with a slot and the pitch mechanism includes a post that extends into the slot and rotation of the handle causes the shaft to act on the post and thereby rotate the pitch mechanism about the first axis. Optionally, the post extends parallel to the first axis. Optionally, the slot is a spiral slot. Optionally, the slot is recessed in the shaft. Optionally, the slot has a first slot end and a second slot end and rotation of the handle in a first rotational handle direction causes the shaft to move the post toward the first slot end. Optionally, rotation of the handle in a second rotational handle direction opposite the first rotational handle direction causes the shaft to move the post toward the second slot end. Optionally, the pitch mechanism includes a vibration device configured to generate vibrations that vibrate the blade. Optionally, a rechargeable battery is for powering the vibration device. Optionally, a vibration device is centered on the first axis.

In certain examples, a method for pivoting a blade of a trowel used for finishing a material surface includes providing a pitch mechanism coupled to the blade and that defines a first axis about which the pitch mechanism is rotatable; operably coupling a handle to the pitch mechanism and the handle extends along and is rotatable about a second axis that is transverse to the first axis; and rotating the handle about the second axis to thereby rotate the pitch mechanism and pivot the blade.

Optionally, pivoting the blade changes pitch angle defined between the blade and the material surface. Optionally, rotation of the handle in a first rotational handle direction causes a first edge of the handle to pivot away from the material surface, and rotation of the handle in a second rotational handle direction opposite the first rotational handle direction causes the first edge to pivot toward the material surface. Optionally, the handle includes a shaft with a slot and the pitch mechanism includes a post that extends into the slot and the rotating the handle causes the shaft to act on the post and thereby rotate the pitch mechanism about the first axis.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A trowel for finishing a material surface, the trowel comprising:
a blade assembly having:
a blade configured to finish the material surface; and
a pitch mechanism coupled to the blade and defining a first axis about which the pitch mechanism is rotatable, whereby as the pitch mechanism rotates about the first axis, the pitch mechanism pivots the blade; and
a handle operably coupled to the blade assembly and extending along a second axis that is transverse to the first axis, wherein the handle is rotatable about the second axis, and wherein rotation of the handle about the second axis rotates the pitch mechanism about the first axis and pivots of the blade.

2. The trowel according to claim 1, wherein pivoting the blade changes pitch angle defined between the blade and the material surface.

3. The trowel according to claim 1, wherein the blade has a first edge, and wherein rotation of the handle in a first rotational handle direction causes the first edge to pivot away from the material surface.

4. The trowel according to claim 3, wherein rotation of the handle in a second rotational handle direction opposite the first rotational handle direction causes the first edge to pivot toward the material surface.

5. The trowel according to claim 3, wherein the first edge extends parallel to the first axis.

6. The trowel according to claim 3, wherein the blade includes a second edge opposite the first edge, and wherein rotation of the handle in a second rotational handle direction opposite the first rotational handle direction causes the second edge to pivot away from the material surface and the first edge to pivot toward the material surface.

7. The trowel according to claim 6, wherein the first edge and the second edge both extend parallel to the first axis.

8. The trowel according to claim 1, wherein the handle includes a shaft with a slot and the pitch mechanism includes a post that extends into the slot; and
wherein the rotation of the handle causes the shaft to act on the post and thereby rotate the pitch mechanism about the first axis.

9. The trowel according to claim 8, wherein the post extends parallel to the first axis.

10. The trowel according to claim 8, wherein the slot is a spiral slot.

11. The trowel according to claim 8, wherein the slot is recessed in the shaft.

12. The trowel according to claim 8, wherein the slot has a first slot end and a second slot end, and wherein rotation of the handle in a first rotational handle direction causes the shaft to move the post toward the first slot end.

13. The trowel according to claim 12, wherein rotation of the handle in a second rotational handle direction opposite the first rotational handle direction causes the shaft to move the post toward the second slot end.

14. The trowel according to claim 1, wherein the pitch mechanism includes a vibration device configured to generate vibrations that vibrate the blade.

15. The trowel according to claim 14, further comprising a rechargeable battery for powering the vibration device.

16. The trowel according to claim 14, wherein the vibration device is centered on the first axis.

17. A method for pivoting a blade of a trowel used for finishing a material surface, the method comprising:
providing a pitch mechanism coupled to the blade and defining a first axis about which the pitch mechanism rotates;
operably coupling a handle to the pitch mechanism, the handle extends along and is rotatable about a second axis that is transverse to the first axis; and
rotating the handle about the second axis to thereby rotate the pitch mechanism and pivot the blade.

18. The method according to claim 17, wherein pivoting the blade changes pitch angle defined between the blade and the material surface.

19. The method according to claim 17, wherein rotation of the handle in a first rotational handle direction causes a first edge of the handle to pivot away from the material surface, and wherein rotation of the handle in a second rotational handle direction opposite the first rotational handle direction causes the first edge to pivot toward the material surface.

20. The method according to claim 17, wherein the handle includes a shaft with a slot and the pitch mechanism includes a post that extends into the slot; and
wherein the rotating the handle causes the shaft to act on the post and thereby rotate the pitch mechanism about the first axis.
